(19) United States
(12) Patent Application Publication
(10) Pub. No.: US 2026/0063596 A1
(43) Pub. Date: Mar. 5, 2026

(54) FLASH EVAPORATOR AND GAS CHROMATOGRAPH

(71) Applicant: SHIMADZU (CHINA) CO., LTD., Shanghai (CN)

(72) Inventors: Dongwei HU, Shanghai (CN); Potsun CHIANG, Shanghai (CN); Chun LI, Shanghai (CN)

(21) Appl. No.: 19/308,061

(22) Filed: Aug. 22, 2025

(30) Foreign Application Priority Data
Aug. 30, 2024 (CN) 202422134033.7

(51) Int. Cl. G01N 30/12; G01N 30/02

(52) U.S. Cl. CPC G01N 30/12; G01N 2030/025; G01N 2030/126

(57) ABSTRACT

The present disclosure relates to a technical field of analysis, and provides a flash evaporator and a gas chromatograph including the flash evaporator, which can avoid pressure buildup of a sample after vaporization and completely vaporize a sample by a heating module. The flash evaporator is applied to sample pretreatment of a gas chromatograph. The flash evaporator includes a sample inlet, a gas sample outlet, a heating module, and a flow restriction device. The heating module communicates with the sample inlet and the gas sample outlet, performs flash evaporation on a liquid sample entering the sample inlet to obtain a gas sample, and delivers the gas sample to the gas chromatograph through the gas sample outlet. In particular, the flash evaporator also includes the flow restriction device disposed in a pipeline between the heating module and the sample inlet.

### BACKGROUND

In some test detection and analysis scenarios, such as when a gas chromatograph analyzes a sample, it is necessary to pre-treat a liquid sample, vaporize the liquid sample into a gas sample, and then perform detection and analysis on the gas sample.

A commonly used vaporization method at present is to heat a liquid sample by a heating module to perform flash vaporization, and uses a needle valve or a solenoid valve to adjust a gas flow rate after vaporization. However, a volume of a liquid after vaporization expands by about 1000 times, that is, a very small amount of liquid sample produces a very large volume of gas, and thus, the gas of the sample obtained by vaporization is restricted, resulting in pressure buildup. Accordingly, a gas pressure becomes higher than an atmospheric pressure, which is easy to cause obtained gas components with high-boiling point to condense, or requires a vaporization temperature higher than that at the atmospheric pressure to ensure the vaporization of the components with high-boiling point, and in this case, substances and components that are sensitive to temperature may be decomposed and denatured.

### SUMMARY

In view of the above problems, the present disclosure provides a flash evaporator and a gas chromatograph including the flash evaporator, which can avoid pressure buildup of a sample after vaporization and completely vaporize the sample by a heating module.

An aspect of the present disclosure provides a flash evaporator which is applied to sample pretreatment of a gas chromatograph. The flash evaporator includes a sample inlet, a gas sample outlet, a heating module, and a flow restriction device. The heating module communicates with the sample inlet and the gas sample outlet, performs flash evaporation on a liquid sample entering the sample inlet to obtain a gas sample, and delivers the gas sample to the gas chromatograph through the gas sample outlet. In particular, the flash evaporator also includes the flow restriction device disposed in a pipeline between the heating module and the sample inlet, and a restricted flow rate of the flow restriction device is adjustable.

According to the technical solution of the present disclosure, the liquid sample enters the flash evaporator from the sample inlet, is restricted to a small flow rate by the flow restriction device, and then enters the heating module for heating and flash vaporization to obtain a gas sample by vaporization. This gas sample is delivered to the gas chromatograph through the gas sample outlet. By controlling the flow restriction device, the flow rate of the liquid sample entering the heating module can be controlled, so that the liquid sample entering the heating module can be completely vaporized. Since the flow restriction device is located before the heating module and the flow rate is adjustable, a flow rate of the gas sample can be adjusted without causing pressure buildup of the sample after vaporization.

As a preferred technical solution, the flow restriction device includes an adjustable flow restrictor, a fixed flow restrictor, a flow meter, and a controller. The fixed flow restrictor is connected to the adjustable flow restrictor in series, the flow meter is used to detect a flow rate in the pipeline where the flow restriction device is disposed, and the controller is communicatively connected to the flow meter and the adjustable flow restrictor separately, and adjusts an opening degree of the adjustable flow restrictor according to the flow rate detected by the flow meter.

According to this preferred technical solution, since a liquid standard sample is always very expensive, and an amount of a liquid sample required in actual analysis is very small because a volume of the liquid sample expands after vaporization, a liquid flow rate needs to be controlled at a very low level, but an adjustable flow restrictor at present is difficult to control the flow rate at a very low level, and even if the flow rate can be control at the very low level, a service life of the adjustable flow restrictor is shortened. Although a fixed flow restrictor can continuously control a liquid flow rate at a low level, the fixed flow restrictor cannot adjust a flow rate of a liquid sample, resulting in inconsistent flow rates of liquid samples with different pressures, and consistency of subsequent sampling is affected. Therefore, by connecting the adjustable flow restrictor and the fixed flow restrictor in series, the flow rate of the liquid sample entering the heating module can be adjusted in a controllable manner, and a service life of the flow restriction device can be extended.

It is worth noting that the flow rate of the gas sample obtained by vaporization can be observed by the flow meter, and the flow rate of the gas sample delivered to the gas chromatograph through the gas sample outlet can be accurately controlled by cooperating with the controller to control the adjustable flow restrictor.

As a preferred technical solution, the adjustable flow restrictor is a needle valve, and the fixed flow restrictor is a damper tube.

According to this preferred technical solution, the flow rate of the liquid sample is adjusted by a combination of the needle valve and the damper tube, so that the needle valve can be adjusted to a very small liquid flow rate at a large opening degree, thereby extending a service life of the needle valve, and saving costs or reducing difficulty of customizing a needle valve with a smaller flow specification.

As a preferred technical solution, the flash evaporator further includes a heat tracing pipe, the flash evaporator communicates with the gas chromatograph via the heat tracing pipe, the heat tracing pipe includes a gas sample outflow pipeline, and two ends of the gas sample outflow pipeline respectively communicate with the heating module and the gas sample outlet.

According to this preferred technical solution, the gas sample passing through the heating module passes through the heat tracing pipe and then enters the gas chromatograph, so that it is further ensured that the sample obtained by vaporization no longer condenses, thereby improving detection accuracy.

As a preferred technical solution, the flash evaporator further includes an exhaust port, and the heat tracing pipe further includes a return gas flow path, one end of the return gas flow path is used to receive the gas sample returned from the gas chromatograph by communicating with a sample outlet of the gas chromatograph, and the other end of the return gas flow path communicates with the exhaust port via the flow meter.

According to this preferred technical solution, the gas sample at the outlet of the gas chromatograph passes through the heat tracing pipe and then flows into the flow meter, so that a dead volume of the flow meter and an influence of trace leakage that is difficult to avoid can be avoided, thereby reducing a purge time in every loading.

As a preferred technical solution, the flow meter is a rotameter.

As a preferred technical solution, the flash evaporator further includes an electric shut-off valve disposed between the flow restriction device and the sample inlet and communicatively connected to the controller.

According to this preferred technical solution, the electric shut-off valve can be controlled by the controller to quickly start/stop the loading of the liquid sample without manual operation, which saves manual effort and is convenient and fast.

As a preferred technical solution, the sample inlet includes a liquid sample inlet and a gas sample inlet, and the flash evaporator further includes a two-way valve and a three-way valve. The two-way valve communicates with the exhaust port, one side of the three-way valve communicates with either the liquid sample inlet or the gas sample inlet, and the other side of the three-way valve communicates with both the electric shut-off valve and the two-way valve.

According to this preferred technical solution, the three-way valve can be switched to receive the liquid sample or the gas sample, so that loading and analysis of the liquid sample and the gas sample can be completed by one flash evaporator. In addition, the two-way valve communicates with the exhaust port, which is convenient for purging a pipeline from the sample inlet to the exhaust port to prevent residue of a previous sample.

As a preferred technical solution, the flash evaporator further includes a filter disposed between the three-way valve and the electric shut-off valve.

According to the preferred technical solution, the filter can filter out some solid particle impurities in the liquid sample to avoid clogging the flow restriction device at a downstream side.

A second aspect of the present disclosure provides a gas chromatograph including the flash evaporator according to any one of the above technical solutions.

### BRIEF DESCRIPTION OF THE SEVERAL VIEWS OF THE DRAWINGS

FIG. 1 is a schematic diagram of a structure of a flash evaporator according to an embodiment of the present disclosure.

FIG. 2 is a schematic diagram of a preferred structure of a flow restriction device according to an embodiment of the present disclosure.

FIG. 3 is a schematic diagram of a preferred structure of a flash evaporator according to an embodiment of the present disclosure.

Reference numerals: flash evaporator 100, gas chromatograph 200, sample inlet 1, liquid sample inlet 11, gas sample inlet 12, three-way valve 13, gas sample outlet 2, heating module 3, flow restriction device 4, adjustable flow restrictor 41, fixed flow restrictor 42, flow meter 43, controller 44, electric shut-off valve 5, heat tracing pipe 6, gas sample outflow pipeline 61, return gas flow path 62, exhaust port 7, two-way valve 8, filter 9.

### DETAILED DESCRIPTION OF THE DISCLOSURE

Technical solutions in embodiments of the present disclosure will be clearly and completely described below with reference to the accompanying drawings in the embodiments of the present disclosure, and obviously, the described embodiments are merely a part of the embodiments of the present disclosure, and are not all embodiments. Based on the embodiments of the present disclosure, all other embodiments obtained by those skilled in the art without creative efforts shall fall within the scope of the present disclosure.

### First Embodiment

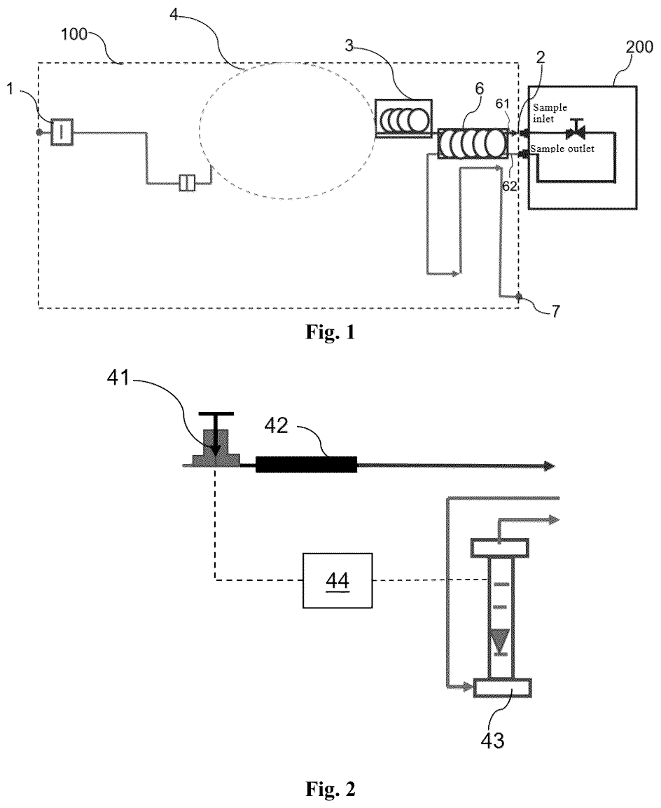

FIG. 1 is a schematic diagram of a structure of a flash evaporator according to an embodiment of the present disclosure. As shown in FIG. 1, a flash evaporator 100 includes a sample inlet 1, a gas sample outlet 2, a heating module 3, and a flow restriction device 4.

The sample inlet 1 at least includes a liquid sample inlet 11, and a technician can inject a liquid sample into the flash evaporator 100 through the liquid sample inlet 11, or the sample inlet 1 can also cooperate with a quantitative extraction device such as a volumetric pump, so that quantitative loading can be automatically completed, and a volume of the loaded liquid sample can be better controlled.

The heating module 3 is disposed on a pipeline at a downstream side of the sample inlet 1, and the heating module 3 may be an electric heater or a heat exchanger, and is not limited thereto. Generally speaking, the heating module 3 needs to be able to wrap and heat a long pipeline. For example, the heating module 3 may be an electric heating box, and the pipeline at the downstream side of the sample inlet is coiled in the electric heating box. The liquid sample entering from the sample inlet 1 is quickly heated and vaporized in the electric heating box along with the pipeline, and a gas sample obtained by vaporization finally flows out from an outlet of the electric heating box, and then is delivered to a gas chromatograph 200 through the gas sample outlet 2.

In particular, the flash evaporator 100 further includes a flow restriction device 4 disposed in the pipeline between the heating module 3 and the sample inlet 1 and configured to restrict a flow rate in an adjustable manner. The flow restriction device 4 may be any device that can restrict a flow rate of a liquid sample to a specified value or value range which is adjustable. The value or value range can be set according to the power of the heating module 3, and can be set as a value or value range in which all liquid samples can be vaporized by the heating module 3 while detection efficiency can be avoided from being reduced.

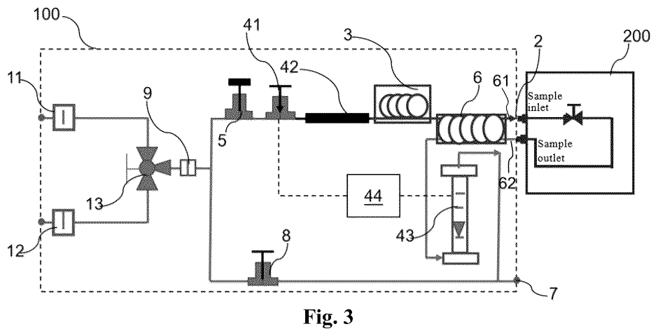

In some preferred technical solutions, the flash evaporator 100 may further include an electric shut-off valve 5 (see FIG. 3), the electric shut-off valve 5 is disposed between the flow restriction device 4 and the sample inlet 1, is communicatively connected to a controller 44, and can be controlled by the controller 44 to quickly start/stop loading of the liquid sample without manual operation, which saves manual effort and is convenient and fast.

Specifically, the liquid sample enters the flash evaporator 100 from the sample inlet 1, is restricted to a small flow rate by the flow restriction device 4, and then enters the heating module 3 for heating and flash vaporization to obtain a gas sample by vaporization. This gas sample is delivered to the gas chromatograph 200 through the gas sample outlet 2.

In the present embodiment, the flow rate of the liquid sample entering the heating module 3 can be controlled by the flow restriction device 4, so that the liquid sample entering the heating module 3 can be completely vaporized. Since the flow restriction device 4 is located before the heating module 3, a flow rate of the gas sample can be adjusted without causing pressure buildup of the sample obtained by vaporization.

### Second Embodiment

FIG. 2 is a schematic diagram of a preferred structure of a flow restriction device according to an embodiment of the present disclosure. As shown in FIG. 2, compared with the first embodiment, a more detailed structure of the flow restriction device 4 is provided in the present embodiment. The flow restriction device 4 includes an adjustable flow restrictor 41, a fixed flow restrictor 42, a flow meter 43, and the controller 44.

The fixed flow restrictor 42 and the adjustable flow restrictor 41 are arranged in series between the sample inlet 1 and a heating unit. The fixed flow restrictor 42 refers to a flow restriction device that can fixedly reduce a liquid flow rate but cannot be adjusted, such as a damper tube or other pressure drop flow restriction devices. The adjustable flow restrictor 41 refers to one that can control a flow rate according to an opening degree of a valve, such as a needle valve and other opening degree control flow restriction devices. It is worth noting that since the adjustable flow restrictor 41 such as a needle valve controls the flow rate of the liquid sample by controlling the opening degree, a too small opening degree may increase a pressure at an upstream side of the valve, and a service life of the valve may be further reduced, or the valve may be damaged.

Since a liquid standard sample is always very expensive, and an amount of a liquid sample required in actual analysis is very small because a volume of the liquid sample expands after vaporization, a liquid flow rate needs to be controlled at a very low level (in some embodiments, the flow rate of the liquid sample needs to be controlled at 0.2 mL/min or less).

Based on a flow restriction principle of the adjustable flow restrictor 41, the adjustable flow restrictor 41 at present is difficult to reach a very low flow rate, and even if the very low flow rate can be reached, the adjustable flow restrictor 41 needs to be kept at a very small opening degree. For example, regarding a needle valve, a needle valve that controls a flow rate to the smallest level on the current market can only barely achieve this effect with an opening degree of a full circle or less, but such a small opening degree seriously affects a service life of the needle valve.

Although the fixed flow restrictor 42 can continuously control the liquid flow rate at a low level, the fixed flow restrictor 42 cannot adjust the flow rate of the liquid sample, resulting in inconsistent flow rates of liquid samples with different pressures, and consistency of subsequent sampling is affected.

Therefore, in the present embodiment, by connecting the adjustable flow restrictor 41 and the fixed flow restrictor 42 in series, the flow rate of the liquid sample entering the heating module 3 can be adjusted in a controllable manner, and a service life of the flow restriction device 4 can be extended.

In addition, in the present embodiment, the flow meter 43 and the controller 44 are further added to the flow restriction device 4. The flow meter 43 may be disposed at a location before or after the heating unit. The flow meter 43 can detect the flow rate in the pipeline where the flow restriction device 4 is disposed. The controller 44 is communicatively connected to the flow meter 43 and the adjustable flow restrictor 41 separately, and adjusts the opening degree of the adjustable flow restrictor 41 according to the flow rate detected by the flow meter 43. For example, the technician can set a predetermined flow rate for the controller 44, acquire a detection result of the flow meter 43 in real time or at intervals, and compare the detection result of the flow meter 43 with the predetermined flow rate. If the detection result of the flow meter 43 is greater than the predetermined flow rate, a control instruction to reduce the opening degree is issued to the adjustable flow restrictor 41, and if the detection result of the flow meter 43 is less than the predetermined flow rate, a control instruction to increase the opening degree is issued to the adjustable flow restrictor 41.

In the present embodiment, the flow rate of the liquid sample is adjusted by a combination of the needle valve and the damper tube, so that the needle valve can be adjusted to reach a very small liquid flow rate at a large opening degree, thereby extending the service life of the needle valve, and saving costs or reducing difficulty of customizing a needle valve with a smaller flow specification. In addition, the flow rate of the gas sample obtained by vaporization can be observed by the flow meter 43, and the flow rate of the gas sample delivered to the gas chromatograph 200 through the gas sample outlet 2 can be accurately controlled by cooperating with the controller 44 to control the adjustable flow restrictor 41.

Note that although the controller 44 is used to adjust the flow rate in the present embodiment, the above description is merely an example, and in other embodiments of the present application, the flow rate can be adjusted in a manual manner.

### Third Embodiment

FIG. 3 is a schematic diagram of a preferred structure of a flash evaporator according to an embodiment of the present disclosure. As shown in FIG. 3, the flash evaporator 100 may further include a heat tracing pipe 6. In some preferred embodiments, the heat tracing pipe 6 is disposed at an inlet of the gas chromatograph 200, that is, the flash evaporator 100 is connected to the gas chromatograph 200 via the heat tracing pipe 6. Specifically, the heat tracing pipe 6 includes a gas sample outflow pipeline 61, and two ends of the gas sample outflow pipeline 61 respectively communicate with the heating module 3 and the gas sample outlet 2. By passing the gas sample obtained by vaporization into the gas chromatograph 200 through the heat tracing pipe 6, it can be ensured that the gas sample passing through the heating module 3 passes through the heat tracing pipe 6 and then enters the gas chromatograph 200, so that it is further ensured that the sample obtained by vaporization no longer condenses, thereby improving the detection accuracy.

Further, in some other preferred embodiments, the heat tracing pipe 6 may also be connected to a sample outlet of the gas chromatograph 200. Specifically, the flash evaporator 100 may further include an exhaust port 7. The heat tracing pipe 6 also includes a return gas flow path 62, one end of the return gas flow path 62 is used to receive the gas sample returned from the gas chromatograph 200 by communicating with the gas chromatograph 200, and the other end of the return gas flow path 62 communicates with the exhaust port 7 via the flow meter 43. The gas sample at the outlet of the gas chromatograph 200 passes through the heat tracing pipe 6 and then flows into the flow meter 43, and thus it can be avoided that the flow rate is reduced due to cooling of the gas sample, so that the reading of the flow meter 43 can truly reflect the flow rate of the gas sample entering the gas chromatograph 200. Preferably, the flow meter 43 is a rotameter 43, which can better reflect the flow rate of the gas sample flowing out of the gas chromatograph 200.

Preferably, the sample inlet 1 includes the liquid sample inlet 11 and a gas sample inlet 12, and the flash evaporator 100 further includes a two-way valve 8 and a three-way valve 13. The two-way valve 8 communicates with the exhaust port 7, one side of the three-way valve 13 communicates with the liquid sample inlet 11 or the gas sample inlet 12, and the other side communicates with the electric shut-off valve 5 and the two-way valve 8. Specifically, by switching the three-way valve 13, it is possible to select the liquid sample inlet 11 to receive the liquid sample, or the gas sample inlet 12 to receive the gas sample for analysis, so that the pretreatment of the liquid sample and the gas sample can be completed by one flash evaporator 100. In addition, the two-way valve communicates with the exhaust port 7, and after once analysis is completed, a pipeline from the sample inlet 1 to the exhaust port 7 can be purged to prevent residue of a previous sample and improve the detection accuracy.

Preferably, the flash evaporator 100 may further include a filter 9 disposed between the three-way valve 13 and the electric shut-off valve 5. The filter 9 may be a metal mesh filter 9. The filter 9 can filter out some solid particle impurities in the liquid sample to avoid clogging the flow restriction device 4 located at the downstream side.

The loading device according to the present embodiment can be applied to the gas chromatograph 200, so that flash vaporization can be performed on the liquid sample to obtain a gas sample, and the gas sample with a certain flow rate can be controlled to continuously flow into the gas chromatograph 200 for analysis, which can ensure that the gas chromatograph 200 performs a more accurate and stable analysis on the sample.

The above embodiments are merely preferred embodiments of the present disclosure and are not intended to limit the present disclosure. Any modifications, equivalent substitutions, and improvements made within the spirit and principles of the present disclosure shall be included in the protection scope of the present disclosure.

What is claimed is:

1. A flash evaporator which is applied to sample pretreatment of a gas chromatograph, the flash evaporator comprising:
a sample inlet;
a gas sample outlet;
a heating module communicating with the sample inlet and the gas sample outlet, and configured to perform flash evaporation on a liquid sample entering the sample inlet to obtain a gas sample, and to deliver the gas sample to the gas chromatograph through the gas sample outlet; and
a flow restriction device disposed in a pipeline between the heating module and the sample inlet, and having an adjustable restricted flow rate.

2. The flash evaporator according to claim 1, wherein the flow restriction device includes:
an adjustable flow restrictor; and
a fixed flow restrictor connected to the adjustable flow restrictor in series, and the flash evaporator further comprises:
a flow meter configured to detect a flow rate in the pipeline where the flow restriction device is disposed; and
a controller communicatively connected to the flow meter and the adjustable flow restrictor separately, and configured to adjust an opening degree of the adjustable flow restrictor according to the flow rate detected by the flow meter.

3. The flash evaporator according to claim 2, wherein the adjustable flow restrictor is a needle valve, and the fixed flow restrictor is a damper tube.

4. The flash evaporator according to claim 2, further comprising:
a heat tracing pipe, wherein the flash evaporator communicates with the gas chromatograph via the heat tracing pipe, the heat tracing pipe includes a gas sample outflow pipeline, and two ends of the gas sample outflow pipeline respectively communicate with the heating module and the gas sample outlet.

5. The flash evaporator according to claim 4, further comprising:
an exhaust port, wherein
the heat tracing pipe further includes a return gas flow path, one end of the return gas flow path is used to receive the gas sample returned from the gas chromatograph by communicating with the gas chromatograph, and the other end of the return gas flow path communicates with the exhaust port via the flow meter.

6. The flash evaporator according to claim 5, wherein the flow meter is a rotameter.

7. The flash evaporator according to claim 5, further comprising:
an electric shut-off valve disposed between the flow restriction device and the sample inlet and communicatively connected to the controller.

8. The flash evaporator according to claim 7, wherein the sample inlet includes a liquid sample inlet and a gas sample inlet, and
the flash evaporator further comprises:
a two-way valve communicating with the exhaust port; and
a three-way valve with one side communicating with either the liquid sample inlet or the gas sample inlet, and the other side communicating with both the electric shut-off valve and the two-way valve.

9. The flash evaporator according to claim 8, further comprising:
a filter disposed between the three-way valve and the electric shut-off valve.

10. A gas chromatograph comprising:
the flash evaporator according claim 1.
